(19) United States
(12) Patent Application Publication
(10) Pub. No.: US 2012/0229125 A1
(43) Pub. Date: Sep. 13, 2012

(54) IRON CORE MEMBER OF A RESOLVER

(76) Inventors: Chao-Chin Teng, Taichung City (TW); Chi-Lu Li, Taichung City (TW); Hsiang-Ju Wang, Taichung City (TW)

(21) Appl. No.: 13/044,437

(22) Filed: Mar. 9, 2011

(51) Int. Cl. G01B 7/30

(52) U.S. Cl. 324/207.25

(57) ABSTRACT

An iron core member of a resolver, which is a one-piece member integrally formed of iron powder. The iron core member includes an annular core section and multiple pole sections annularly arranged on outer circumference of the core section at equal intervals and projecting from the outer circumference of the core section. Each pole section has recessed sections. Enameled wires can be conveniently wound around the recessed sections to form coils located in the recessed sections. The pole section further has multiple projection posts. After the winding process is completed, the terminals of the enameled wires are hooked and located on the projection posts. In comparison with the conventional iron core member, the present iron core member has lower iron loss and the manufacturing process is simplified.

### BACKGROUND OF THE INVENTION

1. Field of the Invention

The present invention relates generally to a resolver, and more particularly to an iron core member of a resolver.

2. Description of the Related Art

A conventional resolver is used to feed back angular positions of a motor to a drive device. The conventional resolver includes excitation coils and induction coils. The excitation coils serve as excitation signal sources to provide excitation signals. The induction coils serve to sense magnetic field change and achieve corresponding amplitude modulation signals to feed back signals of angular position of the motor. In structure, the coils are formed of enameled wires, which are wound on the poles of the iron core member of the resolver. After the winding process is completed, the terminals of the enameled wires must be manually affixed to the coils by means of a suitable adhesive.

Moreover, the conventional iron core member is composed of multiple stacked silicon steel sheets. In general, the iron loss of the silicon steel sheets is in direct proportion to the frequency. That is, the higher the frequency is, the greater the iron loss is.

Therefore, the silicon steel sheets can be only used as the components of the iron core member of a common rotary motor. With respect to a resolver, the excitation frequency of the resolver is within a KHz range. Under such a high-frequency circumstance, in case the iron core member of the resolver is composed of silicon steel sheets, the silicon steel sheets will lead to too high iron loss. This will directly affect the correctness of the operational result of the resolver.

Therefore, with respect to the conventional technique, the too high iron loss will deteriorate the working result of the resolver. Also, the iron core member lacks any structure for easily winding and locating the enameled wires. As a result, the manufacturing and assembling efficiency is low. Also, the stability of the manufacturing process and the reliability of the product are poor. Especially with respect to a magnetoresistive resolver, both the excitation coils and the induction coils are formed of enameled wires wound around the poles of the stator iron core. Therefore, in the case that the number of the poles is increased to enhance the precision, the winding process will be more complicated and troublesome. This is an obstacle to the promotion of the quality of the resolver.

### SUMMARY OF THE INVENTION

It is therefore a primary object of the present invention to provide an iron core member of a resolver with lower iron loss. Enameled wires can be conveniently wound on the iron core member to form the coils. After the winding process is completed, the coils are securely located.

To achieve the above and other objects, the iron core member of the resolver of the present invention includes a core section with a curvature center and multiple pole sections annularly arranged on outer circumference of the core section at equal intervals and centered at the curvature center of the core section. The pole sections project from the outer circumference of the core section. Each pole section has an elongated pole body. A periphery of the pole body is recessed to form at least one recessed section. The recessed section extends around an axis of the pole section by a predetermined angle. The core section and the pole sections are integrally formed of iron powder.

The present invention can be best understood through the following description and accompanying drawings, wherein:

### BRIEF DESCRIPTION OF THE DRAWINGS

FIG. 1 is a perspective view of a preferred embodiment of the present invention;

FIG. 2 is an enlarged view of a part of the preferred embodiment of the present invention; and

FIG. 3 is a perspective view according to FIG. 2, showing that enameled wires are wound around the pole sections of the iron core member of the present invention to form the coils.

### DETAILED DESCRIPTION OF THE PREFERRED EMBODIMENT

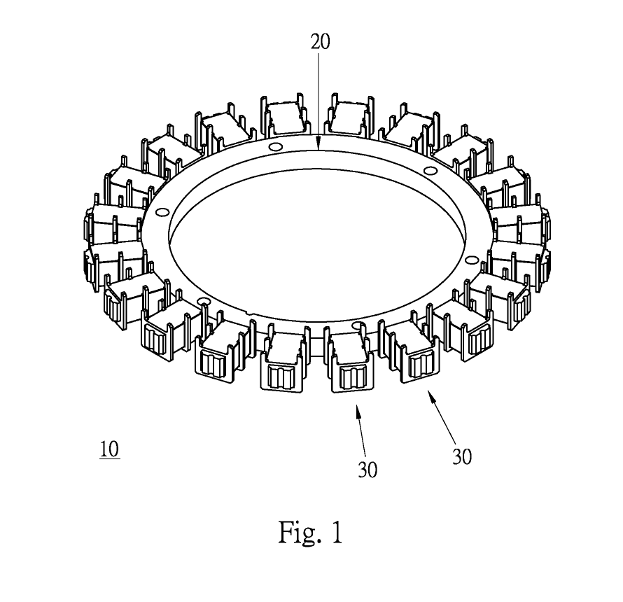

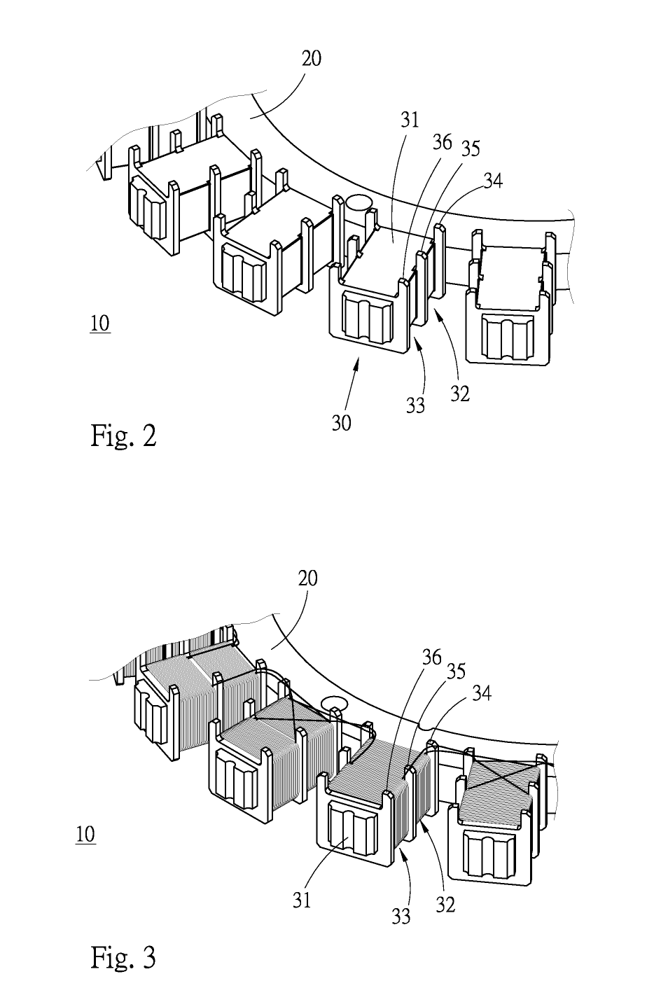

Please refer to FIGS. 1 and 2. According to a preferred embodiment, the iron core member 10 of the resolver of the present invention is applied to a stator of a magnetoresistive resolver. The iron core member 10 includes a core section 20 and multiple pole sections 30. The core section 20 and the pole sections 30 are integrally formed of iron powder by die-casting.

The core section 20 is an annular plate body with a curvature center.

The pole sections 30 are annularly arranged on outer circumference of the core section 20 at equal intervals and centered at the curvature center of the core section 20. The pole sections 30 project from the outer circumference of the core section 20. Each pole section 30 has a substantially rectangular solid pole body 31. A first end of the pole body 31 is connected to the outer circumference of the core section 20. A periphery of the pole body 31 is recessed to form a first recessed section 32 and a second recessed section 33. The first and second recessed section 32, 33 are lengthwise sequentially disposed on the pole body 31. The first and second recessed sections 32, 33 extend around an axis of the pole section 31 by about 270 degrees. The first recessed section 32 is defined between a first wall and a second wall. The second recessed section 33 is defined between the second wall and a third wall. A first pair of projection posts 34, a second pair of projection posts 35 and a third pair of projection posts 36 are disposed on the pole body 31 and project therefrom. The projection posts 34, 35, 36 are respectively positioned at starting ends and terminal ends of the first and second recessed sections 32, 33. To speak more specifically, the first, second and third pairs of projection posts 34, 35, 36 are respectively positioned on the first, second and third walls.

Please now refer to FIG. 3. According to the above arrangement, the enameled wires can be wound around the recessed sections 32, 33 of the iron core member 10 to form the coils in the recessed sections 32, 33. After the winding process is completed, the terminals of the enameled wires are respectively wound over the first pair of projection posts 34 or the second pair of projection posts 35 and then extended to another pole section for further winding. The third pair of projection posts 36 serves to provide a restriction and stop effect to prevent the coils from detaching from the pole section. In other words, on one hand, the first or second pair of projection posts 34, 35 of the iron core member 10 serves to provide locating effect for the terminals of the enameled wires and on the other hand, the coils can be securely located in the recessed sections 32, 33. Accordingly, the winding and assembling process of the coils is simplified. Moreover, the enameled wires can be continuously extended and wound on different pole sections 30. In this case, the winding process can be automated to ensure the stability of the manufacturing process and the reliability of the product.

Furthermore, the core section 20 and the pole sections 30 are integrally formed of iron powder by die-casting. Therefore, under a KHz excitation frequency circumstance, the iron core member 10 has lower iron loss. Accordingly, when the iron core member 10 of the present invention is applied to a stator of a magnetoresistive resolver, the iron core member 10 has better performance in working. Therefore, the resolver can more precisely feed back amplitude modulation signals. The conventional iron core member is composed of multiple stacked silicon steel sheets. The silicon steel sheets are located by means of a locating tool and welded with each other by means of a laser-welding machine. Such processes are quite complicated and troublesome. In comparison with the conventional iron core member, the manufacturing process of the iron core member 10 of the present invention is simplified so that the manufacturing efficiency is greatly enhanced.

The above embodiment is only used to illustrate the present invention, not intended to limit the scope thereof. Many modifications of the above embodiment can be made without departing from the spirit of the present invention.

What is claimed is:

1. An iron core member of a resolver, comprising:
a core section with a curvature center; and
multiple pole sections annularly arranged on outer circumference of the core section at equal intervals and centered at the curvature center of the core section, the pole sections projecting from the outer circumference of the core section, each pole section having an elongated pole body, a periphery of the pole body being recessed to form at least one recessed section, the recessed section extending around an axis of the pole section by a predetermined angle, the core section and the pole sections being integrally formed of iron powder.

2. The iron core member of the resolver as claimed in claim 1, wherein each pole section further has at least one pair of projection posts, which are disposed on the pole body at intervals and project from the pole body, the recessed section being defined between a first wall and a second wall, the pair of projection posts being positioned on the first wall of the recessed section.

3. The iron core member of the resolver as claimed in claim 2, wherein each pole section having two pairs of projection posts respectively positioned on the first and second walls of the recessed section.

4. The iron core member of the resolver as claimed in claim 1, wherein the pole section has a first recessed section and a second recessed section, which are lengthwise sequentially disposed on the pole body.

5. The iron core member of the resolver as claimed in claim 4, wherein each pole section has three pairs of projection posts, which are disposed on the pole body at intervals and project from the pole body, the first recessed section being defined between a first wall and a second wall, the second recessed section being defined between the second wall and a third wall, the first, second and third pairs of projection posts being respectively positioned on the first, second and third walls.

6. The iron core member of the resolver as claimed in claim 1, wherein the recessed section extends around the axis of the pole section by 270 degrees.

7. The iron core member of the resolver as claimed in claim 1, wherein the core section has the form of an annular plate.
